(19) United States
(12) Patent Application Publication
(10) Pub. No.: US 2007/0274716 A1
(43) Pub. Date: Nov. 29, 2007

(54) Methods and apparatus to provide local warning of a low battery condition from an optical network terminal

(76) Inventors: Goangshiuan Shawn Ying, Oakland, CA (US); Eugene L. Edmon, Danville, CA (US); James Carlyle, San Ramon, CA (US); Steve Aspell, Brentwood, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/432,237

(22) Filed: May 11, 2006

(51) Int. Cl. H04B 10/20; H04J 14/00

(52) U.S. Cl. 398/58

(57) ABSTRACT

Methods and apparatus for providing local warning of a low battery condition from an optical network terminal to a device in a customer premises are disclosed. An example optical network terminal is coupled to a power supply having a battery. The power supply sends a data signal to the optical network terminal indicating a condition of the battery. The optical network terminal includes a data port to receive the data signal from the power supply. The optical network terminal has a computer data port. A controller is provided to read the data signal and send a warning signal of the battery condition via the computer port to a device in a customer premises serviced by the power supply.

### FIELD OF THE DISCLOSURE

This disclosure relates generally to power regulation of optical equipment, and, more particularly, to methods and apparatus to provide local warning of a low battery condition from an optical network terminal.

### BACKGROUND

Recent demands for high speed data connections to households for multiple services has resulted in greater use of fiber optical networks. Fiber optical networks carry data for multiple services to a household. In fiber to the premises (FTTP) broadband passive optical network (B-PON) and gigabit passive optical network (G-PON) architectures, an optical network terminal (ONT) provides the customer interfaces for services such as telephone, high-speed Internet data, and cable TV. An optical network terminal is a single, integrated device and is environmentally hardened for exterior installation on the customer premises.

Because the facility-connection to the central office is fiber, the optical network terminal cannot be line powered from the central office. A DC Uninterruptible Power Supply (UPS) is installed inside the customer premises for powering the ONT. The UPS converts the customer's commercial 120-V, 60-Hz AC power to low-voltage DC power and includes a battery to provide back up power if AC power fails. A UPS typically provides a series of LED displays on the UPS unit to alert the customer of: presence of AC power, presence of DC power and/or need for battery replacement.

The UPS also typically provides several alarms describing the status of the battery in the unit including alarms warning of a low battery, a need to replace the battery, a missing battery or no battery. The UPS relays warning messages to the ONT. These warning messages may be relayed by the ONT back to the central office. However, in many instances, the UPS belongs to the subscriber or the home owner, and a service provider is not responsible to maintain the health of the battery. As such, the service provider may not receive the battery related alarms and/or ignore the same. The UPS system which supplies battery power backup to the ONT is usually located in an inconvenient location such as a basement, wiring closet, or garage, where alarm notification systems such as an audio warming device or LED cannot be heard or seen very easily. If the subscriber has not received the warning message and the battery has not been replaced, the UPS system will not function properly during a power outage and the provided services, such as phone service, will be affected (e.g., disabled).

### BRIEF DESCRIPTION OF DRAWINGS

FIG. 1 is an example optical fiber system to deliver optical data to an optical network terminal in a destination location.

FIG. 2 is a perspective view of an example power supply for the example optical network terminal in FIG. 1.

FIG. 3 is a cutaway view of the example optical network terminal in FIG. 1.

FIG. 4 is a block diagram of the example optical network terminal in FIG. 3 to provide a low battery warning.

FIG. 5 is a block diagram illustrating an example apparatus to provide local warning of a low battery condition which may be integrated in the ONT of FIG. 4.

FIGS. 6A-6B are flow diagrams of machine readable instructions which may be executed to implement the apparatus of FIG. 5.

### DETAILED DESCRIPTION

In general example methods and apparatus to provide local warning of a low battery in a UPS from an optical network terminal to a device located in the customer premises are disclosed. An example optical network terminal is coupled to a power supply having a battery. The power supply sends a data signal to the optical network terminal indicating a condition of the battery. The optical network terminal includes a data port to receive the data signal from the power supply. The optical network terminal has a computer data port. A controller is provided to read the data signal and send a warning signal of the battery condition via the computer port to a device in a customer premises serviced by the power supply.

Another example optical network terminal is coupled to a power supply having a battery. The power supply sends a data signal to the optical network terminal indicating a battery condition. The optical network terminal includes a data port to receive the data signal from the power supply. The optical network terminal also includes a video data port to send a video signal to a television display. Logic responsive to the data signal to send a warning signal indicating the battery condition to the television display is also provided.

Another example method of providing a warning of a battery condition from a power source coupled to an optical network terminal includes detecting a signal indicative of a battery condition at the power source. A warning signal is sent from the optical network terminal to a computer in a customer premises associated with the optical network terminal when the signal indicative of a battery condition is detected.

Another example method of providing a warning of a battery condition from a power source having a power line and a data line coupled to an optical network terminal having a video port includes detecting a signal indicative of a battery condition at the power source. A warning signal is sent from the optical network terminal to a television coupled to a video port on the optical network terminal when the signal indicative of a battery condition is detected on the data line.

Another example is an article of manufacture storing machine readable instructions which, when executed, cause an optical network terminal to detect a signal indicative of a battery condition at a power source. The instructions also cause the terminal to send a warning signal from the optical network terminal to a computer in a customer premises associated with the optical network terminal when the signal is detected.

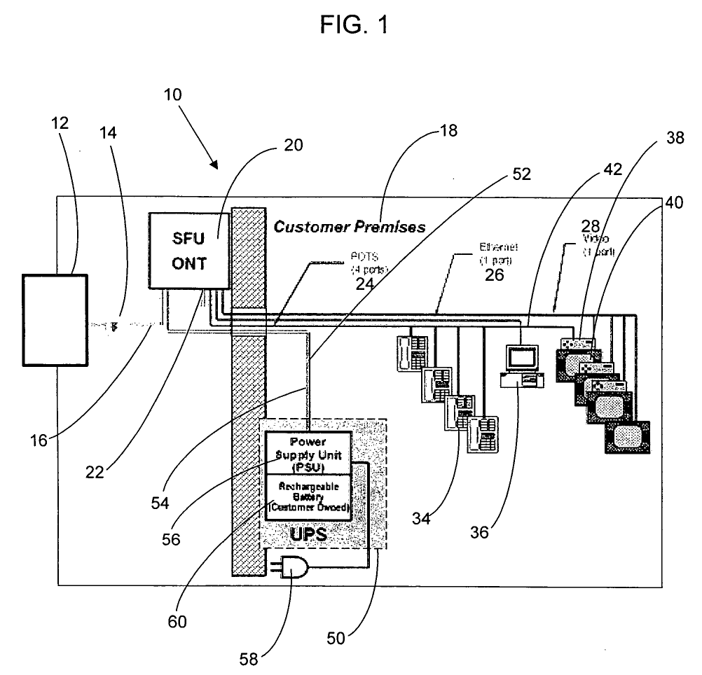

FIG. 1 is a block diagram of an example household system 10 which is connected to a fiber optical central office 12 via a fiber optic network 14 ending in a fiber optic cable 16 which delivers data to a customer premises 18 such as a household or business. The customer premises 18 has an optical network terminal (ONT) 20 installed. In this example, the optical network terminal 20 is mounted on the exterior of the customer premises 18 and is coupled to the fiber optic cable 16.

The ONT 20 has multiple output ports 22. In the illustrated example, the output ports 22 include a telephone service line 24, an Ethernet service line 26 and a video service cable 28. Those provided and/or other types of ports may be included on the ONT 20.

Multiple devices, which are generally located in the customer premises 18, may be coupled to the output ports 22. In this example, the devices include one or more telephones 34 connected to the telephone line 24, one or more personal computing devices 36 connected to the Ethernet line 26, and one or more television set top boxes 38 connected to the video service cable 28. The set top box 38 provides video service to a television 40. Optionally, a telephone line 42 may be coupled to the set top box 38 to provide communications for services such as video on demand or other interactive television services. Those of ordinary skill in the art will recognize that the ONT 20 may be used for Internet Protocol Television (IPTV) by use of the Ethernet line 26.

The ONT 20 is powered by an uninterruptible power supply (UPS) 50 which is mounted on the interior of the customer premises 18. The UPS 50 supplies power to the ONT 20 via a power line 52. Operational data from the UPS 50 is also relayed to the ONT 20 via a data line 54. The UPS 50 includes a power supply unit 56 which is coupled to a plug 58 which is connected to household AC power supply. The power supply unit 56 includes a transformer (not shown) to convert AC power to DC power which is output to the power line 52 at a voltage suitable for powering the ONT 20. The UPS 50 also has a battery 60 which supplies backup power to the ONT 20 in the event of failure of the AC power supply. The battery 60 may or may not be rechargeable.

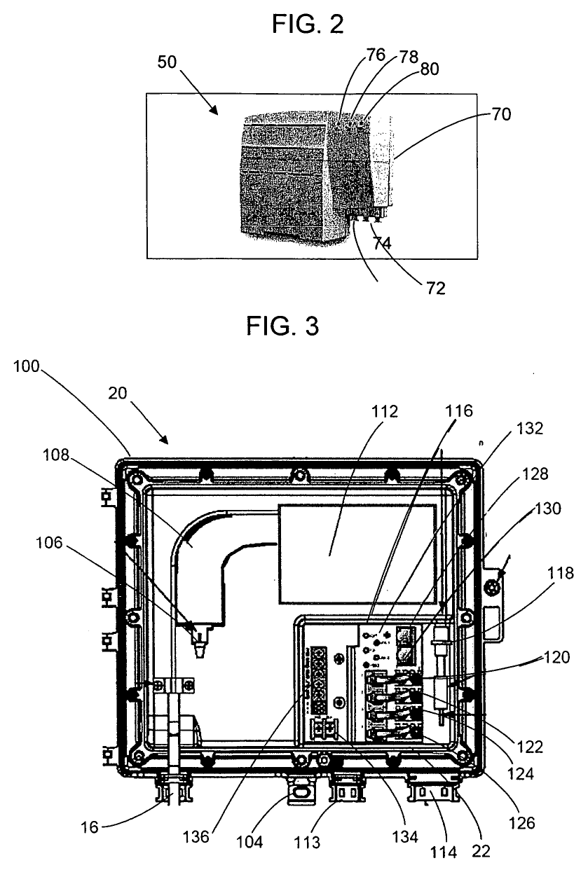

FIG. 2 is a perspective view of the example UPS 50 in FIG. 1. The UPS 50 has an outer casing 70 that houses the above mentioned components. The outer casing 70 has a DC power output port 72 which is coupled to the power line 52 and a data port 74 which is coupled to the data line 54. The UPS 50 has a low battery LED 76, a replace battery LED 78 and a battery missing LED 80. The LEDs 76-80 provide warning indications of battery conditions. In addition, the power supply unit 56 sends a data signal over the data line 54 to the ONT 20 in FIG. 1 regarding battery conditions. On receiving the data signal relating to battery conditions, the ONT 20 may relay a message relating to battery conditions to the central office 12 in FIG. 1.

FIG. 3 is a top cutaway view of an example ONT such as the ONT 20. The ONT 20 in the illustrated example is used with a broadband passive optical network (B-PON). However, those of ordinary skill in the art will recognize that the ONT 20 with appropriate modifications may be used 20 has a casing 100 with mounting brackets 102 and 104. The optical fiber cable 16 is terminated in an SC/Angled Physical contact (APC) connector 106. The SC/APC connector 106 is coupled to a buffer tube 108 which guides a fiber splice 110 to a fiber splice holder 112. A power grommet 113 accepts the power line 52 and the data line 54 (not shown in FIG. 3) from the UPS 50 in FIG. 1. An output grommet 114 holds the telephone service lines 24, Ethernet service lines 26, and the coaxial video cable line 28.

A network interface board 116 includes the service outputs 22. In this example, the network interface board 116 has a video connection 118 which is coupled to the coaxial video service cable 28. The network interface board 116 in this example has four telephone connectors 120, 122, 124 and 126 which are used for connection to phone lines such as the telephone service line 24 in FIG. 1. The network interface board 116 in this example has two Ethernet connectors 128 and 130 for connection to Ethernet lines such as the Ethernet service lines 26 in FIG. 1. The network interface board 116 has a number of status LEDs 132 which indicate the status of the telephone connectors 120-126, video connection 118 and the Ethernet connectors 128-130. The network interface board 116 has a power supply input 134 and a power supply data input 136 for connection to the power line 52 and the data line 54, respectively. A user service interface 138 is provided to set user information.

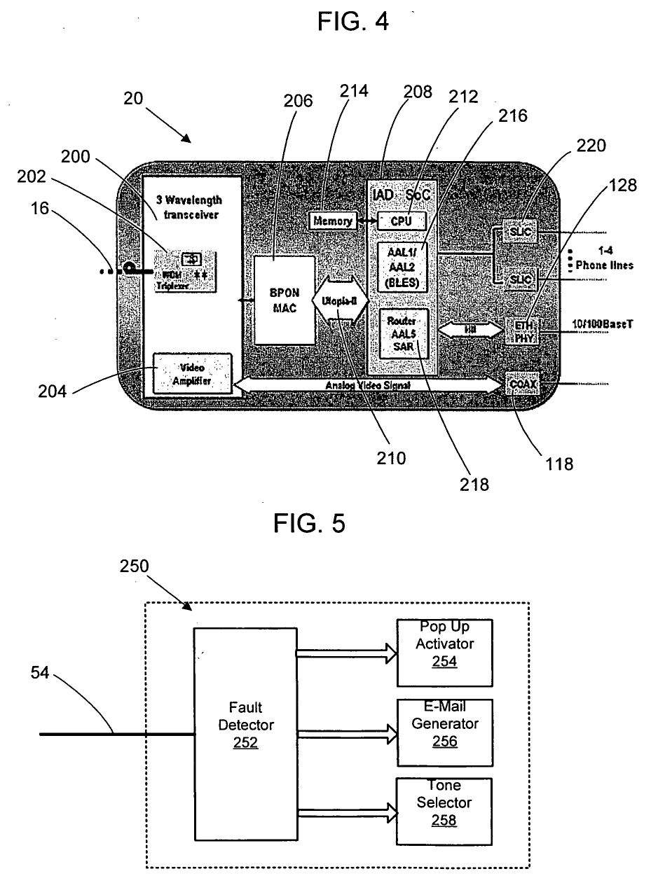

FIG. 4 is a block diagram of the electrical and logic components of the ONT 20. The ONT 20 in the illustrated example has a three wavelength transceiver 200 which accepts data modulated on the optical fiber cable 16 on three different wavelengths. The three wavelengths on the optical fiber 16 in this example are used for receiving data, sending burst traffic, and receiving an analog video signal. Those of ordinary skill in the art will understand that a wide range of wavelengths may be transmitted on the optical fiber cable 16. The transceiver 200 includes a wavelength division multiplexing (WDM) triplexer 202 and a video amplifier 204. The video amplifier 204 outputs an analog video signal to the video cable connector 118. Of course, those of ordinary skill in the art will understand that digital video signals can also be received by the video amplifier 204 with appropriate hardware and software.

The ONT 20 includes a broadband passive optical network media access control (BPON MAC) 206 which is coupled to an integrated access device (IAD) 208 via an asynchronous transfer mode (ATM) bus 210. In this example, the IAD 208 is a system on chip (SoC) but other hardware and software layouts may be used. The BPON MAC 206 controls the burst mode of data transmission used to send signals from the customer premises 18 over the fiber optic cable 16. The BPON MAC 206 also filters the data from the fiber optic cable 16 which is intended for the particular customer premises 18. The IAD 208 includes a controller which is a central processing unit (CPU) 212 coupled to a memory 214. The IAD 208 further includes a data processing module 216 and a router 218. The IAD 208 outputs phone data to a subscriber line interface card (SLIC) 220 which is coupled to the phone connectors 120-126. The SLIC 220 includes the logic needed to terminate the tip and ring signaling from the phone or phones along with a codec to convert analog to digital voice streams. Computer data is handled via the router 218 which sends and receives data to the Ethernet connectors 128-130. Those of ordinary skill in the art will appreciate that for GPON operation, the BPON MAC 206 could be replaced with a GPON medium access control device.

In addition to relaying the battery alarms obtained from the UPS 50 to the central office 12, the ONT 20 uses the local service ports 22 to send out warning signals to the subscriber directly via the devices coupled to the local service ports 22. On receiving a warning message on the data line 54 from the UPS 60, the ONT 20 will send message alerts over the ports 22 to the telephone 34, the computer 36 and/or the television set top box 38. As will be explained below, the ONT 20 may be configured to send warning messages to selected devices or to all devices which are connected to the ports 22. The warning messages are formatted by the CPU 212 and inserted into the data which is output to the various outputs 22. The content of the different warning messages are stored in the memory 214.

In sending a warning signal via the Ethernet ports 128 or 130, when first configured, the CPU 212 and router 218 of the ONT 20 learn the Ethernet media access control (MAC) address of all devices such as the personal computer 38 in FIG. 1 which are connected to the Ethernet port or ports. The CPU 212 of the ONT 20 then sends a warning message to the devices using the MAC address. In some examples, a pop-up warning window describing the fault status of the battery is displayed on the computer screen of the personal computer 38 using the operating system software of the personal computer 38 and/or on the on the display to the television 40 using the operating system of the STB 38.

The ONT 20 is also capable of allowing a user to acknowledge the fault condition shown in the pop-up window. The acknowledgement can either prevent further warnings of the same fault event from popping up again until the fault condition is fixed, or allow the pop-up to be displayed periodically until the fault condition is fixed.

A different example method to send a warning message to the subscriber employs the ONT 20 to use a message application programming interface (MAPI) in the data control module 216 to send a mail message to subscriber's email account on the personal computer 38 via the router 218.

In sending a warning signal via the television 40 in FIG. 1, the CPU 212 uses the message service to superimpose a message stored in memory 214 on programming display on the television 40 in FIG. 1 via the STB 38. The CPU uses the SLIC 220 to transmit message data for the set top box 38 to overlay an alert message on the display of the television 40. Alternatively, the ONT 20 may support Internet Protocol Television (IPTV) in which the broadcast signal is sent via an Ethernet connection such as the Ethernet port 26 to the set top box 38 for display to the television 40. In an example using IPTV, the CPU 212 of the illustrated example in the ONT 20 forwards the warning message via a pop-up warning window which the set top box 38 imposes on the television picture.

In sending a warning signal via the telephone connectors 120-126, one or more special tones or pre-recorded verbal messages are stored on the memory 214 of the ONT 20 or in dedicated memory on the SLIC 220. When the subscriber picks up the phone (e.g. the telephone 34), the special tone(s) or recorded verbal message(s) are played via the SLIC 220 to provide notification about the battery's fault condition. The ONT 20 supports off-hook event monitoring via the data input from the SLIC 220. The phone off-hook signaling message is intercepted via the SLIC 220. The SLIC 220 also receives an acknowledge key, such as # or * on the phone, which will acknowledge the message, terminate the message, and permit the phone call to proceed. The acknowledge key may either mute the fault announcement for the current call or prevent future fault announcements on future calls until a new fault condition appears.

FIG. 5 is a block diagram of an example apparatus 250 to implement the warnings of a battery condition to the devices in the consumer premises. The apparatus 250 may, for example, be implemented by a logic circuit in communication with or integral to the IAD 208, or may be implemented by software and/or firmware executed by the CPU 212. The example apparatus 250 includes a fault detector 252 which reads data from the data line 54 from the UPS 50. Depending on the devices in the consumer premises 18 in FIG. 1, the fault detector 252 can activate a pop up activator 254, an e-mail generator 256 and/or a tone selector 258 to send a warning message to one or more devices in the customer premises 18. The pop up activator 254 of the illustrated example responds to an activation signal from the fault detector 252 reading an appropriate stored message from the memory 214 and sending a pop up message to a computer such as the computer 36 in FIG. 1 or to the STB 38 for display of the pop up message on a display and/or the television 40. The e-mail generator 256 of the illustrated example responds to an activation signal from the fault detector 252 to generate one or more of a set of predetermined e-mail messages for transmission over the Ethernet line 26 to the computer 36 in FIG. 1. The tone selector 258 of the illustrated example responds to an activation signal from the fault detector 252 to provide a tone or audio warning from the memory 214 to the SLIC 220 for transmission to a telephone such as the telephone 24 in FIG. 1. The pop up activator 254, the e-mail generator 256 and/or the tone selector 258 have access to the memory 214 which stores the network addresses of the devices to be alerted to the low battery condition to facilitate this messaging.

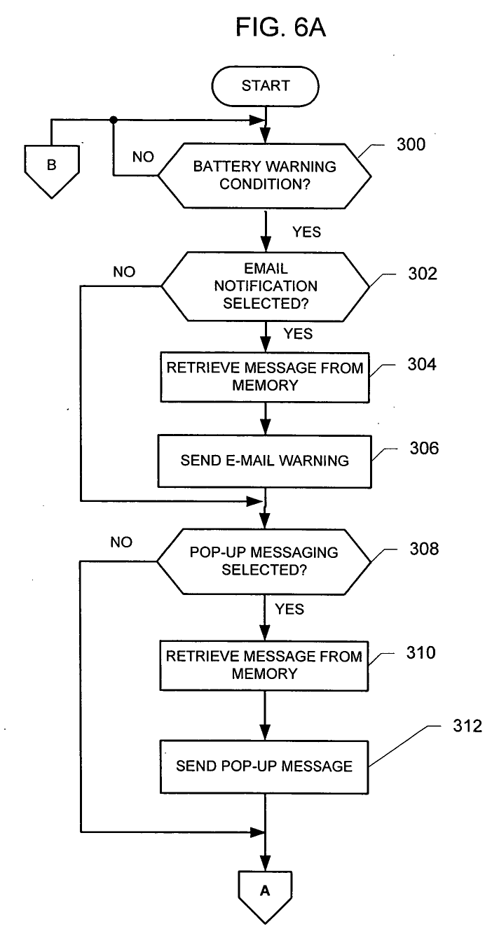

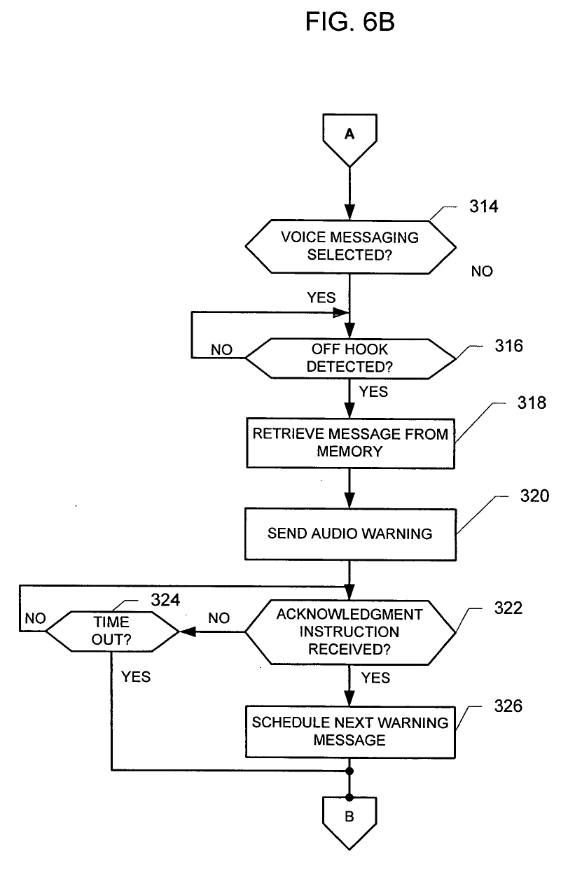

A flowchart representative of example machine readable instructions for implementing the apparatus 250 of FIG. 5 is shown in FIG. 6. In this example, the machine readable instructions comprise a program for execution by: (a) a processor such as the processor 212 shown in FIG. 4, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory 214 associated with the processor 212, but persons of ordinary skill in the art will readily appreciate that the entire program and/or parts thereof could alternatively be executed by a device other than the processor 212 and/or embodied in firmware or dedicated hardware in a well known manner (e.g., it maybe implemented by an application specific integrated circuit (ASIC), a programmable logic device (PLD), a field programmable logic device (FPLD), discrete logic, etc.). For example, any or all of the fault detector 252, the pop up activator 254, the-email generator 256, and/or the tone selector 258 could be implemented by software, hardware, and/or firmware. Also, some or all of the machine readable instructions represented by the flowchart of FIG. 6 may be implemented manually. Further, although the example program is described with reference to the flowchart illustrated in FIG. 6, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The example program of FIG. 6 begins at block 300 where the fault detector 252 waits to receive a signal from the UPS indicative of a battery warning condition. Upon receipt of such a message (block 300), the fault detector 252 determines if the ONT 20 has been set for sending e-mail notifications of the battery state (block 302). If the e-mail notification is set in block 302, the e-mail generator 256 retrieves an appropriate message from the memory 214 (block 204). If the e-mail notification is not set, the apparatus 250 then proceeds to block 308. The e-mail generator 256 then sends an e-mail warning to devices such as the computer 38 which are coupled to the Ethernet ports 128 or 130 in FIG. 4. The apparatus 250 then determines if pop up messaging is set (block 308). If the pop up messaging is not set, the apparatus 250 the proceeds to block 314. If pop up messaging is set in block 308, the pop up activator 254 retrieves an appropriate pop up message from the memory 214 (block 310). The pop up activator 254 then sends the pop up message over the Ethernet port 128 and/or over the phone line 42 to the STB 38 for display on the television 40 in FIG. 1 (block 312).

The apparatus 250 determines whether voice messaging has been set in block 314. If voice messaging has been set, the apparatus 250 detects whether an off hook condition exists on any of the phones connected to the phone lines (block 316). If there are not phones in the off hook condition, the apparatus 250 will continue to detect the off hook condition exists (block 316). If an off hook condition exists, tone selector 258 retrieves an audio message and/or an audio tone from the memory 214 (block 318). The tone selector 258 then sends an audio warning in the form of the audio message and/or the audio tone (block 320).

The apparatus 250 determines whether an acknowledgment instruction is received from any of the devices receiving the warning (block 322). If no acknowledgement is received, the apparatus 250 determines whether a time out has occurred (block 324). If the time out has occurred, the apparatus 250 returns to block 300 to detect further warning signals. If the time out has not occurred, the apparatus loops back to block 322 to continue to check for receipt of an acknowledgement. If an acknowledgment instruction is received, the apparatus schedules the sending of the next warning message via one or all of the appropriate pop up activator 254, e-mail generator 256 and/or tone selector 258 to the selected device. The apparatus then returns to block 300.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An optical network terminal coupled to a power supply having a battery, the power supply to send a data signal to the optical network terminal indicating a condition of the battery, the optical network terminal comprising:
a first data port to receive the data signal from the power supply;
a second data port; and
a controller to read the data signal and send a warning signal of the battery condition via the second data port to a device in a customer premises serviced by the power supply.

2. The optical network terminal of claim 1 further comprising a video feed connected to a set top box associated with a television screen, wherein the controller sends a second warning signal of the battery condition to the set top box for display on the television screen.

3. The optical network terminal of claim 2 wherein the video feed transmits an Internet Protocol Television (IPTV) signal.

4. The optical network terminal of claim 1 further comprising a telephone port, wherein the controller sends a third warning signal of the battery condition via the telephone port to a telephone in the customer premises.

5. The optical network terminal of claim 4 wherein the third warning signal is an audio sound.

6. The optical network terminal of claim 4 wherein the third warning signal is an audio voice message.

7. The optical network terminal of claim 1 wherein the device is a computer and the warning signal is a pop-up message type displayable on a computer screen.

8. The optical network terminal of claim 1 wherein the device is a computer and the warning signal is an e-mail.

9. The optical network terminal of claim 8 wherein the e-mail requests an acknowledgement message, requiring an acknowledgment action by a user.

10. The optical network terminal of claim 1 wherein the second data port is an Ethernet connection.

11. An optical network terminal coupled to a power supply having a battery, the power supply to send a data signal to the optical network terminal indicating a battery condition, the optical network terminal comprising:
a first data port to receive the data signal from the power supply;
a video data port to send a video signal to a television display; and
logic responsive to the data signal to send a warning signal indicating the battery condition to the television display.

12. The optical network terminal of claim 11 wherein the video signal is an Internet Protocol Television (IPTV) signal.

13. The optical network terminal of claim 11 further comprising a computer data port, the logic to send a warning signal of the battery condition via the computer data port.

14. The optical network terminal of claim 11 further comprising a telephone port, wherein the logic to send a warning signal via the telephone port.

15. The optical network terminal of claim 14 wherein the telephone port is coupled to a set top box, and the video data port is coupled to the set top box, the set top box superimposing a warning message on the television display.

16. A method of providing a warning of a battery condition from a power source coupled to an optical network terminal, the method comprising:
detecting a signal indicative of a battery condition at the power source; and
sending a warning signal from the optical network terminal to a computer in a customer premises associated with the optical network terminal when the signal indicative of a battery condition is detected.

17. The method of claim 16 further comprising sending a second warning signal from the optical network terminal to a telephone connected to a telephone port on the optical network terminal when the signal indicative of a battery condition is detected.

18. The method of claim 16 further comprising sending a second warning signal from the optical network terminal to display a warning message on the television when the signal indicative of a battery condition is detected on the data line.

19. A method of providing a warning of a battery condition from a power source having a power line and a data line coupled to an optical network terminal having a video port, the method comprising:
detecting a signal indicative of a battery condition at the power source; and
sending a warning signal from the optical network terminal to a television coupled to a video port on the optical network terminal when the signal indicative of a battery condition is detected on the data line.

20. The method of claim 19 further comprising sending a second warning signal from the optical network terminal to a telephone connected to a telephone port on the optical network terminal when the signal indicative of a battery condition is detected.

21. The method of claim 19 further sending a second warning signal from the optical network terminal to a computer coupled to a computer data port on the optical network terminal the signal indicative of a battery condition is detected.

22. An article of manufacture storing machine readable instructions which, when executed, cause the optical network terminal, to:
detect a signal indicative of a battery condition at a power source; and
send a warning signal from the optical network terminal to a computer in a customer premises associated with the optical network terminal when the signal indicative of a battery condition is detected.

23. The article of manufacture of claim 22, wherein the instructions further cause the optical network terminal to send a second warning signal to a telephone.

24. An apparatus to provide warning of a battery condition in a power source to a device in a customer premises, comprising:
a fault detector to detect a battery condition; and
at least one of:
a pop-up activator to transmit a pop-up message to a device in the customer premises indicating the battery condition; or
an e-mail generator to transmit an e-mail to a device in the customer premises indicating the battery condition.

25. The apparatus of claim 24 further comprising a tone selector to transmit an audio warning to a telephone.

26. A computer to receive a battery condition warning from a power source coupled to an optical network terminal, the computer comprising:
a data port to receive a data signal including the battery condition warning from the optical network terminal; and
a display coupled to the data port to display a warning of the battery condition.

27. A television to receive a battery condition warning from a power source coupled to an optical network terminal, the television comprising:
a video data port to receive a video data signal including the battery condition warning from the optical network terminal; and
a display coupled to the data port to display a warning of the battery condition.
